(19) United States
(12) Patent Application Publication
(10) Pub. No.: US 2007/0122577 A1
(43) Pub. Date: May 31, 2007

(54) Polypropylene-base molded article and container

(75) Inventors: Toshiharu Iwasaki, Kawasaki-shi (JP); Masataka Kotani, Yokohama-shi (JP); Katsuyuki Yoshikawa, Ichihara-shi (JP)

Correspondence Address: SUGHRUE MION, PLLC, 2100 PENNSYLVANIA AVENUE, N.W., SUITE 800, WASHINGTON, DC, 20037, US

(73) Assignee: Showa Denko Plastic Products Co., Ltd., Tokyo (JP)

(21) Appl. No.: 10/572,704

(22) PCT Filed: Sep. 21, 2004
(86) PCT No.: PCT/JP04/14135

§ 371 Date: Mar. 17, 2006

Related U.S. Application Data
(60) Provisional application No. 60/509,267, filed on Oct. 8, 2003.

(30) Foreign Application Priority Data
Sep. 22, 2003 (JP) 2003-330347

(51) Int. Cl. B32B 27/32; B32B 27/08; B32B 1/02

(52) U.S. Cl. 428/35.7; 428/523; 428/516; 525/240

(57) ABSTRACT

One of the objects of the present invention is to provide a molded article excellent in all of transparency, impact resistance, flexibility and blocking resistance. The present invention provides the polypropylene-base molded article of the present invention is a single-layer or multilayer molded article having a layer comprising a thermoplastic resin composition containing a polypropylene resin composition (A) satisfying the following requirements and an ethylene-base copolymer (B) comprising an ethylene and at least one α-olefin having 4 or more carbon atoms. The polypropylene resin composition (A) is a composition where a polypropylene component (C) and a copolymer elastomer component (D) of propylene, ethylene and/or α-olefin having from 4 to 12 carbon atoms are contained each in a specific range, the melt flow rate is in a specific range, the content of the unit originated in the propylene in the copolymer elastomer component (D) is specified, and the xylene-soluble portion Xₛ satisfies specific requirements.

### CROSS-REFERENCE TO RELATED APPLICATIONS

This application claims the benefit pursuant to 35 U.S.C. §119 (e) of U.S. Provisional Application No. 60/509267 filed on Oct. 8, 2003, and prioirity is claimed on Japanese Patent Application No. 2003-330347, filed Sep. 22, 2003, and a Provisional Application No. 60/509267 filed on Oct. 8, 2003, the content of which is incorporated herein by reference.

### TECHNICAL FIELD

The present invention relates to a molded article comprising a polypropylene-base resin composition and also relates to a container which can be used particularly as a medical container.

### BACKGROUND ART

Medical containers in which blood, medicament or the like is filled are required to have, needless to say about hygiene, heat resistance high enough to endure high-temperature sterilization treatment, transparency to render it possible to confirm the presence or absence of foreign matters mingled or view the change due to blending of medicaments, impact resistance capable of preventing rupture at the dropping during handling or at the packing and transportation, flexibility to realize easy discharge of contents, and blocking resistance not to cause easy separation of film or sheet at the production of a medical container and at the same time, not to cause adhesion of the medical container containing a medicament to its outer packaging bag.

In particular, demands are increasing for a medical container which can be sterilized at a high temperature of 121° C. or more of giving a strong sterilizing effect, satisfied in all of heat resistance, transparency, impact resistance, flexibility and blocking resistance, and industrially produced.

For medical containers, soft vinyl chlorides, polyethylene-base materials such as high-pressure process low-density polyethylene, linear low-density polyethylene, high-density polyethylene and ethylene-vinyl acetate copolymer, and polypropylene-base materials such as propylene homopolymer and random or block copolymer of propylene and other α-olefins have been heretofore used.

Vinyl chloride-base resins have a problem in that the plasticizer used for imparting its performance dissolves out into the medical solution or food, despite excellent balance of heat resistance, transparency, flexibility and impact resistance.

Out of the polyethylene-base materials, the high-pressure process low-density polyethylene is poor in the heat resistance and impact strength. As for the linear low-density polyethylene, a polyethylene having a low density is used so as to enhance the transparency or flexibility, but reduction in the density incurs problems, for example, the heat resistance tends to be insufficient or the low molecular weight component in the resin causes reduction in the blocking resistance of the container or dissolves out into the medicament. The ethylene-vinyl acetate copolymer is excellent in the transparency but disadvantageously poor in the heat resistance. The high-density polyethylene is poor in the transparency. In other words, good balance of heat resistance, transparency and impact resistance can be hardly obtained in the polyethylene-base materials.

Out of polypropylene-base materials, the propylene homopolymer and the propylene random copolymer are excellent in the transparency but inferior in the impact resistance, and the propylene block copolymer is poor in the flexibility and transparency.

In order to solve these problems, as for the medical container using a polyethylene-base material, a multilayer container consisting of a layer mainly comprising a high-density polyethylene and a layer mainly comprising a linear low-density polyethylene has been proposed (see, for example, Japanese Unexamined Patent Application, First Publication No. H5-293160).

Also, a polyethylene-base material produced by using a metallocene-base catalyst and having excellent impact resistance and transparency has been recently developed and there is a movement to apply this material to medical containers. For example, a container obtained by combining polyethylene-base materials produced in the presence of a metallocene-base catalyst and stacking these materials in two or three layers has been proposed (see, for example, Japanese Unexamined Patent Application, First Publication No H7-125738).

On the other hand, as for the medical container using a polypropylene-base material, a container imparted with excellent property in the heat resistance, transparency, impact resistance and the like by using a resin composition comprising a mixture of a propylene-base random copolymer having an α-olefin content of 5 to 8% by mass and specific ethylene-propylene and ethylene-butene random copolymers has been disclosed (see, for example, Japanese Unexamined Patent Application, First Publication No H8-231787).

Also, a container constituted by an outer layer and an intermediate layer has been proposed, where the outer layer is a layer comprising a propylene homopolymer or propylene-α-olefin random copolymer containing from 0 to 30% of a polyethylene-base resin and the intermediate layer is a stacked body of three layers comprising a mixture of a propylene homopolymer or a propylene/α-olefin random copolymer and an olefin-base elastomer or the like (see, for example, Japanese Unexamined Patent Application, First Publication No H9-262948).

Furthermore, a container obtained by using a resin composition comprising a crystalline polypropylene and a propylene-α-olefin copolymer having a specific intrinsic viscosity ratio, and forming a specific morphology at the thermal molding has been proposed (see, for example, Japanese Unexamined Patent Application, First Publication No H10-316810).

In the inventions of these publications, the object is to obtain a medical container satisfied in all of heat resistance, transparency, impact resistance, flexibility and blocking resistance, and capable of being industrially produced, but these inventions all are failing in satisfying at least one performance out of heat resistance, transparency, impact resistance, flexibility and blocking resistance.

The present invention has been made under these circumstances and an object of the present invention is to provide a molded article and a container which are excellent in all of heat resistance, transparency, impact resistance, flexibility and blocking resistance and can be used particularly as a medical container.

### DISCLOSURE OF INVENTION

As a result of intensive investigations to solve those problems, the present inventors have found that the above-described object can be attained by a molded article having a layer comprising a thermoplastic resin composition containing a specific polypropylene resin composition and an ethylene-base copolymer, and also by a container using the molded article. The polypropylene-base molded article of (1) to (10) below and the container of (11) to (18) below have been invented based on this finding.

(1) A polypropylene-base molded article having at least one layer comprising a thermoplastic resin composition, wherein the thermoplastic resin composition contains a polypropylene resin composition (A) satisfying the following requirements and an ethylene-base copolymer (B) comprising an ethylene and at least one α-olefin having 4 or more carbon atoms:

the polypropylene resin composition (A) is a composition containing from 50 to 80% by mass of a polypropylene component (C) and from 50 to 20% by mass of a copolymer elastomer component (D) of propylene, ethylene and/or α-olefin having from 4 to 12 carbon atoms,

the melt flow rate is in the range from 0.1 to 15.0 g/10 min,

the content of the unit originated in the propylene in the copolymer elastomer component (D) is from 50 to 85% by mass, and

the xylene-soluble portion Xₛ satisfies the following requirements (I) to (V):

(I) the propylene content Fₚ is from 50 to 80% by mass,

(II) the intrinsic viscosity [η]_{Xs} of the xylene-soluble portion Xₛ is from 1.4 to 5 dL/g,

(III) the ratio of the intrinsic viscosity [η]_{Xs} to the intrinsic viscosity [η]_{Xi} of the xylene-insoluble portion Xᵢ is from 0.7 to 1.5,

(IV) the propylene content (Pₚ) of the high propylene content component as defined according to the two-site model is from 60% by mass to less than 95% by mass and the propylene content (P′ₚ) of the low propylene content component is from 20% by mass to less than 60% by mass, and

(V) the propylene content (Pₚ) of the high propylene content component as defined according to the two-site model, the propylene content (P′ₚ) of the low propylene content component, the ratio (P_{fl}) of the high propylene content component occupying in Fₚ, and the ratio (1-P_{fl}) of the low propylene content component occupying in Fₚ satisfy the following formulae (1) and (2):
Pₚ/P′ₚ≧1.90 (1)
2.00<P_{fl}/(1-P_{fl})<6.00 (2)

(2) The polypropylene-base molded article as described in (1), wherein the refractive index of the xylene-soluble portion in the thermoplastic resin composition is from 1.480 to 1.495.

(3) The polypropylene-base molded article as described in (1) or (2), wherein the amount of the xylene-soluble portion in the thermoplastic resin composition is from 20 to 70% by mass.

(4) The polypropylene-base molded article as described in any one of (1) to (3), wherein in the thermoplastic resin composition, the ratio (MFR_{A}/MFR_{B}) of the melt flow rate (MFR_{A}) of the polypropylene resin composition (A) to the melt flow rate (MFR_{B}) of the ethylene-base copolymer (B) is from 0.3 to 3.0.

(5) The polypropylene-base molded article as described in any one of (1) to (4), which is a multilayer polypropylene-base molded article and further has a layer comprising a polyolefin-base resin.

(6) The polypropylene-base molded article as described in (5), wherein the polyolefin-base resin is a polyethylene-base resin.

(7) The polypropylene-base molded article as described in (6), wherein the polyethylene-base resin contains 15% by mass or more of a high-density polyethylene.

(8) The polypropylene-base molded article as described in (6), wherein the polyethylene-base resin comprises substantially only a high-density polyethylene.

(9) The polypropylene-base molded article as described in any one of (1) to (8), wherein the thickness of the layer comprising a thermoplastic resin composition accounts for 40% or more of the entire thickness.

(10) The polypropylene-base molded article as described in any one of (1) to (9), which is produced by a multilayer co-extrusion water-cooling inflation molding method or a multilayer co-extrusion T-die casting method.

(11) A container comprising the polypropylene-base molded article described in any one of (1) to (10).

(12) The container as described in (11), wherein the container comprises a multilayer polypropylene-base molded article and the outermost layer is a layer comprising a polypropylene resin composition or a propylene-α-olefin random copolymer.

(13) The container as described in (11), wherein the container comprises a multilayer polypropylene-base molded article and the outermost layer is a layer containing a polyethylene-base resin.

(14) The container as described in (13), wherein the polyethylene-base resin contains 15% by mass or more of a high-density polyethylene.

(15) The container as described in (13), wherein the polyethylene-base resin comprises substantially only a high-density polyethylene.

(16) The container as described in any one of (11) to (15), wherein the container comprises a multilayer polypropylene-base molded article and the innermost layer is a layer containing a polyethylene-base resin.

(17) The container as described in (16), wherein the polyethylene-base resin comprises substantially only a high-density polyethylene.

(18) The container as described in any one of (11) to (17), which is a medical container for housing a medical substance.

### BRIEF DESCRIPTION OF THE DRAWINGS

FIG. 1 is a view showing one example of ¹³C-NMR spectrum of propylene-ethylene copolymer elastomer.

FIG. 2 is a view showing names of respective carbons originated in the chain distribution.

### MODES FOR CARRYING OUT THE INVENTION

Polypropylene-Base Molded Article

The polypropylene-base molded article of the present invention is a single-layer molded article comprising a thermoplastic resin composition containing a polypropylene resin composition (A) [hereinafter sometimes simply referred to as a “component (A)”] and an ethylene-base copolymer (B) [hereinafter sometimes simply referred to as a “component (B)”], or a multilayer molded article having at least one layer comprising the thermoplastic resin composition. This is particularly a thin-wall molded article having flexibility, such as tube, sheet and film.

The polypropylene resin composition (A) is a composition containing a polypropylene component (C) [hereinafter sometimes simply referred to as a “component (C)”] and a copolymer elastomer component (D) of propylene, ethylene and/or α-olefin having from 4 to 12 carbon atoms [hereinafter sometimes simply referred to as a “component (D)”].

The polypropylene component (C) constituting the polypropylene resin composition (A) is selected from a propylene homopolymer, a copolymer of propylene, ethylene and/or α-olefin having from 4 to 12 carbon atoms, and a mixture thereof. As for the α-olefin having from 4 to 12 carbon atoms, an arbitrary member selected from 1-butene, 1-pentene, 1-hexene, 1-heptene, 1-octene, 1-decene, 4-methyl- 1-pentene and the like can be used. These may be used individually or in combination of two or more thereof.

However, in the present invention, the polypropylene component (C) indicates a polymer where the content of the unit originated in propylene is exceeding 95% by mass. The content of ethylene and/or α-olefin as the copolymerization component is 5.0% by mass or less, preferably from 0.1 to 3.5% by mass. If the content of ethylene and/or α-olefin having from 4 to 12 carbon atoms exceeds 5% by mass, the molded article extremely decreases in rigidity and heat resistance.

This polymer is produced according to a known polymerization method by using, for example, a known Ziegler-Natta catalyst or metallocene catalyst.

Among those polymers, in the case where the final molded article or container is required to have particularly rigidity and heat resistance, the polypropylene component (C) is preferably a propylene homopolymer, and in the case where the final molded article or container is required to have particularly impact resistance and transparency, the polypropylene component (C) is preferably a copolymer of propylene, ethylene and/or α-olefin having from 4 to 12 carbon atoms.

The polypropylene component (C) preferably has a intrinsic viscosity [η] of 2.0 to 4.8 dL/g, more preferably from 2.5 to 4.5 dL/g, still more preferably from 2.8 to 4.0 dL/g. If the intrinsic viscosity [η] exceeds 4.8 dL/g, there may arise extrusion failure at the molding or reduction in the transparency of the molded article, whereas if the intrinsic viscosity [η] is less than 2.0 dL/g, extrusion failure at the molding or reduction in the transparency less occurs, but the product may decrease in rigidity and impact resistance.

The copolymer elastomer component (D) is a copolymer elastomer component of propylene, ethylene and/or α-olefin having from 4 to 12 carbon atoms. As for the α-olefin having from 4 to 12 carbon atoms constituting the copolymer elastomer component (D), an arbitrary olefin may be used and specific examples thereof include 1-butene, 1-pentene, 1-hexene, 1-heptene, 1-octene, 1-decene and 4-methyl-1-pentene.

However, in the present invention, the copolymer elastomer component (D) indicates a polymer where the content of the unit originated in propylene is from 50 to 85% by mass. The content of the unit originated in propylene is preferably from 55 to 85% by mass, more preferably from 55 to 80% by mass. If the content of the unit originated in propylene exceeds 85% by mass, the impact resistance at low temperatures becomes insufficient, whereas if it is less than 50% by mass, the transparency or heat seal strength may decrease.

These polypropylene component (C) and copolymer elastomer component (D) can be produced by a known method. More specifically, these components can be produced by polymerizing a propylene or copolymerizing a propylene and other olefins, in the presence of a Ziegler catalyst or a metallocene catalyst. The Ziegler catalyst used here includes a titanium trichloride-base catalyst and a magnesium-supported catalyst. The magnesium-supported catalyst includes catalysts constituted by (a) a solid catalyst component containing titanium, magnesium and halogen as essential components, (b) an organic aluminum compound and (c) an electron-donating compound. These catalysts are described, for example, in JP-A-57-63310, JP-A-57-63311, JP-A-58-83006, JP-A-58-138708, JP-A-62-20507, JP-A-61-296006, JP-A-2-229806, JP-A-2-33103 and JP-A-2-70708. These may also be used as a prepolymerization catalyst resulting from polymerization of a small amount of olefin in advance of the production of each component.

In the production of the copolymer elastomer component (D), the production conditions are not particularly limited as long as this component can be produced to satisfy the ranges specified in the present invention, but specific examples of the method therefor include the following methods:

1. a method of producing the component (D) by using, out of those catalysts, a catalyst of giving a polymer having a relative wide composition distribution, tacticity distribution or molecular weight distribution,

2. a method of producing the component (D) by using a catalyst described above which is prepared under the conditions of giving a relatively wide composition distribution, tacticity distribution or molecular weight distribution, that is, prepared by changing the amount of the electron-donating compound or organic aluminum compound used or using a plurality of electron-donating compounds,

3. a method of producing the component (D) under the polymerization conditions of giving a relatively wide composition distribution, tacticity distribution or molecular weight distribution, that is, (a) a method of producing the component (D) through multistage polymerization by changing the polymerization conditions of each stage, such as temperature and monomer compositional ratio, or (b) a method of producing the component (D) by utilizing the fact that the composition distribution changes according to the composition of the polymer obtained, and controlling the composition of the copolymer elastomer so that an objective composition distribution can be obtained, and

4. a method of mixing a plurality of components having a uniform composition distribution and differing in the propylene content, which are obtained by using a metallocene catalyst or the like.

When the component (D) used is produced by such a method, a polypropylene resin composition (A) controlled in the composition distribution of the xylene-soluble portion as described later can be easily obtained.

In the production of the components (C) and (D), a polymerization method which is performed in the presence of an inactive hydrocarbon such as hexane, heptane and kerosine, or a liquefied α-olefin solvent such as propylene, for example, slurry polymerization, block polymerization, solution polymerization or gas phase polymerization, can be employed. The polymerization is performed at a temperature ranging from room temperature to 200° C., preferably from 30 to 150° C., under a pressure ranging from 0.2 to 5.0 MPa. As for the reactor used in the polymerization step, a reactor commonly used in this technical field can be appropriately used and examples thereof include a stirring tank-type reactor, a fluidized bed-type reactor and a circulating system reactor. The polymerization can be performed in a continuous, semi-batch or batch system by using such a reactor. At the polymerization, hydrogen or the like may be added to adjust the molecular weight of the polymer obtained.

The polypropylene resin composition (A) contains from 50 to 80% by mass of a polypropylene component (C) and from 50 to 20% by mass of a copolymer elastomer component (D). If the content of the copolymer elastomer component (D) is less than 20% by mass, poor impact resistance results, whereas if it exceeds 50% by mass, inferior rigidity or heat resistance results. The content of the copolymer elastomer component (D) is preferably from 45 to 20% by mass, more preferably from 40 to 23% by mass, because excellent impact resistance, rigidity and heat resistance can be obtained.

The polypropylene resin composition (A) has a melt flow rate (hereinafter sometimes referred to as “MFR”) of 0.1 to 15.0 g/10 min, and in view of transparency, rigidity and impact strength of the molded article, more preferably from 0.5 to 10.0 g/10 min, still more preferably from 0.7 to 7.0 g/10 min. If the MFR is less than 0.1 g/10 min, dispersion failure or ejection failure of each component may occur at the kneading or molding by an extruder and this may give rise to reduction in the impact resistance, rigidity or transparency of the molded article, whereas if the MFR exceeds 15.0 g/10 min, the impact resistance or transparency may decrease. The MFR as used in the present invention is a value measured at 230° C. under a load of 21.18 N according to JIS K 7210.

The polypropylene resin composition (A) usually contains from 20 to 50% by mass of a xylene-soluble portion Xₛ. The content of the xylene-soluble portion Xₛ is preferably from 20 to 45% by mass, more preferably from 23 to 40% by mass.

The ratio of the xylene soluble portion Xₛ is determined as follows.

A test sample (10 g) is added to 1 L of ortho-xylene and stirred under heating and by elevating the temperature to the boiling temperature (about 135° C.), the test sample is completely dissolved over 30 minutes or more. After confirming the complete dissolution with an eye, the solution is allowed to cool with stirring to 100° C. or less and further held for 2 hours in a constant temperature chamber kept at 25° C. Thereafter, the precipitated component (xylene-insoluble portion Xᵢ) is separated through a filter paper to obtain a filtrate. While heating this filtrate at a temperature of 140° C., xylene is distilled out in a nitrogen stream (about 1 L/min) and the residue is dried to obtain the xylene-soluble portion Xₛ. At this time, the drying of the xylene-insoluble portion and xylene-soluble portion is performed at 60° C. under reduced pressure for 1 day. The ratio of the xylene-soluble potion is determined by (mass of Xₛ/mass of test sample). The xylene-soluble portion is composed of low molecular matters and amorphous molecules in the resin composition.

(I) The propylene content Fₚ in the xylene-soluble portion is from 50 to 80% by mass, preferably from 60 to 80% by mass, more preferably from more than 60% by mass to 80% by mass, still more preferably from 65 to 80% by mass, yet still more preferably from 70 to 80% by mass, and most preferably from 70 to 78% by mass. If the propylene content in the xylene-soluble portion is less than 50% by mass, the transparency decreases and when a film is formed, the heat seal strength may decrease, whereas if the propylene content Fₚ exceeds 80% by mass, the impact resistance at low temperatures decreases.

(II) The intrinsic viscosity [η]_{Xs} of the xylene-soluble portion is from 1.4 to 5.0 dL/g, preferably from 2.0 to 4.5 dL/g, more preferably from 2.5 to 4.0 dL/g. If the intrinsic viscosity [η]_{Xs} exceeds 5.0 dL/g, the impact resistance is enhanced but the transparency decreases, whereas if the intrinsic viscosity [η]_{Xs} is less than 1.4 dl/g, the impact resistance decreases.

(III) The ratio ([η]_{Xs}/[η]_{Xi}) of the intrinsic viscosity [η]_{Xs} of the xylene-soluble portion to the intrinsic viscosity [η]_{Xi} of the xylene-insoluble portion is from 0.7 to 1.5, preferably from 0.7 to 1.3, more preferably from 0.8 to 1.2. If the ratio ([η]_{Xs}/[η]_{Xi}) is less than 0.7, the transparency is enhanced but the impact resistance at low temperatures decreases, whereas if it exceeds 1.5, the transparency decreases.

The refractive index of the xylene-soluble portion in the polypropylene resin composition (A) is preferably from 1.470 to 1.490, more preferably from 1.470 to 1.485, still more preferably 1.473 to 1.485. If the refractive index of the xylene-soluble portion exceeds 1.490, the transparency is enhanced but the impact resistance may decrease, whereas if it is less than 1.470, the impact resistance is enhanced but the transparency tends to decrease.

The refractive index of the xylene-soluble portion is determined as follows.

The xylene-soluble portion is preheated at 230° C. for 5 minutes by a press-molding machine, degassed for 30 seconds, pressed at 6 MPa for 1 minute and cooled at 30° C. for 3 minutes to obtain a film having a thickness of 50 to 80 μm. Thereafter, a test sample comprising this film is left standing at an ordinary temperature for 24 hours and then the refractive index for a sodium D line is measured at 23° C. by an Abbe's refractometer produced by ATAGO while using ethyl salicylate as an intermediate solution.

The refractive index of the xylene-insoluble portion, which is determined in the same manner as the refractive index of the xylene-soluble portion, is preferably 1.490 to 1.510, more preferably from 1.493 to 1.505, still more preferably from 1.495 to 1.503. If the refractive index of the xylene-insoluble portion is less than 1.490, the transparency and impact resistance are enhanced but the rigidity and heat resistance decrease, whereas if it exceeds 1.510, the rigidity and heat resistance are enhanced but the impact resistance tends to decrease.

In the xylene-soluble portion Xₛ of the polypropylene resin composition (A), (IV) the propylene content (Pₚ) of the high propylene content component as defined according to the two-site model is from 60% by mass to less than 95% by mass, preferably from 65 to 90% by mass, more preferably from 70 to 90% by mass, and the propylene content (P′ₚ) of the low propylene content component is from 20% by mass to less than 60% by mass, preferably from 25 to 55% by mass, more preferably from 30 to 50% by mass.

In the xylene-soluble portion Xₛ of the polypropylene resin composition (A), (V) the propylene content Pₚ of the high propylene content component as defined according-to the two-site model, the propylene content P′ₚ of the low propylene content component, the ratio P_{fl} of the high propylene content component occupying in Fₚ, and the ratio (1-P_{fl}) of the low propylene content component occupying in Fₚ satisfy the following formulae (1) and (2):
Pₚ/P′ₚ≧1.90 (1)
2.00<P_{fl}/(1-P_{fl})<6.00 (2)

If Pₚ/P′ₚ is less than 1.90 or P_{fl}/(1-P_{fl}) is 2.00 or less, the interface strength between the xylene-soluble portion and the xylene-insoluble portion decreases and therefore, at the time of producing a container by heat-sealing the molded article, the heat seal strength decreases. If P_{fl}/(1-P_{fl}) is 6.00 or more, the above-described interface strength is enhanced, but the rigidity or impact strength decreases. These formulae are indexes for showing the composition distribution of the xylene-soluble portion, that is, formula (1) is a measure of the compositional difference between components produced from those two active sites and formula (2) is a measure regarding the production of components produced from those two active sites.

With respect to Pₚ, P′ₚ and P_{fl} obtained according to the two-site model, Pₚ/P′ₚ preferably satisfies the following formula (3), more preferably the following formula (4):
1.95≦Pₚ/P′ₚ≦2.40 (3)
1.95≦Pₚ/P′ₚ≦2.35 (4)

Also, P_{fl}/(1-P_{fl}) preferably satisfies the following formula (5), more preferably the following formula (6):
250≦P_{fl}/(1-P_{fl})<550 (5)
3.00<P_{fl}(1-P_{fl})<5.00 (6)

The two-site model is defined in H. N. Cheng, Journal of Applied Polymer Science, Vol. 35, pp. 1639-1650 (1988). More specifically, by assuming two active sites, that is, an active site (P) of preferentially polymerizing propylene and an active site (P′) of preferentially polymerizing ethylene, the reaction probability at these two active sites is determined, more specifically, the propylene contents Pₚ and P′ₚ and the ratio P_{fl} of the active site (P) of preferentially polymerizing propylene, occupying in the entire active site, are employed as parameters and by using the probability equations shown in Table 1, these three parameters are optimized such that the relative strength of the actual ¹³C-NMR spectrum agrees with the probability equations. The thus-obtained Pₚ, P′ₚ and P_{fl} and the propylene content Fₚ satisfy the relationship of the following formula (7):
Fₚ=Pₚ×P_{fl}+P′ₚ×(1-P_{fl}) (7)

TABLE 1

| Signal | | Probability Equations of Two-Site Model |
|---|---|---|
| (1) | Sαα | Pₚ² × P_{f1} + P′ₚ² × (1 − P_{f1}) |
| (2) | Sαγ | (−2Pₚ³ + 2Pₚ²) × P_{f1} + (−2P′ₚ³ + 2P′ₚ²) × (1 − P_{f1}) |
| (3) | Sαδ | (2Pₚ³ − 4Pₚ² + 2Pₚ) × P_{f1} + (2P′ₚ³ − 4P′ₚ² + 2P′ₚ) × |
| | | (1 − P_{f1}) |
| (4) | Tδδ | (Pₚ³ − 2Pₚ² + Pₚ) × P_{f1} + (P′ₚ³ − 2P′ₚ² + P′ₚ) × (1 − P_{f1}) |
| (5) | Sγγ + | (Pₚ⁴ − 4Pₚ² + 3Pₚ²) × P_{f1} + (P′ₚ⁴ − 4Pₚ³ + 3P′ₚ²) × |
| | Tβδ | (1 − P_{f1}) |
| (6) | Sγδ | (−2Pₚ⁴ + 6Pₚ³ − 6Pₚ² + 2Pₚ) × P_{f1} + (−2P′ₚ⁴ + |
| | | 6P′ₚ³ − 6P′ₚ² + 2P′ₚ) × (1 − P_{f1}) |
| (7) | Sδδ | (Pₚ⁴ − 5Pₚ³ + 9Pₚ² − 7Pₚ + 2) × P_{f1} + (P′ₚ⁴ − 5P′ₚ³ + |
| | | 9P′ₚ² − 7P′ₚ + 2) × (1 − P_{f1}) |
| (8) | Tββ | Pₚ³ × P_{f1} + P′ₚ³ × (1 − P_{f1}) |
| (9) | Sβδ | (2Pₚ³ − 4Pₚ² + 2Pₚ) × P_{f1} + (2P′ₚ³ − 4P′ₚ² + 2P′ₚ) × |
| | | (1 − P_{f1}) |
| (10) | Sββ | (−Pₚ³ + 2Pₚ²) × P_{f1} + (−P′ₚ³ + P′ₚ²) × (1 − P_{f1}) |

The two-site model is described below by taking the propylene-ethylene copolymer elastomer as an example.

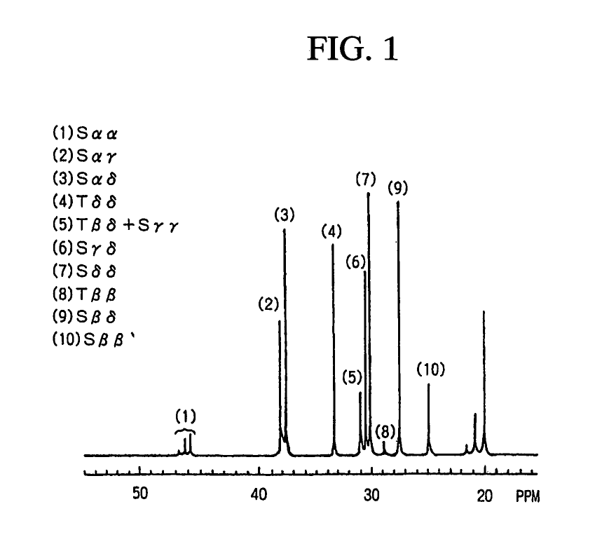

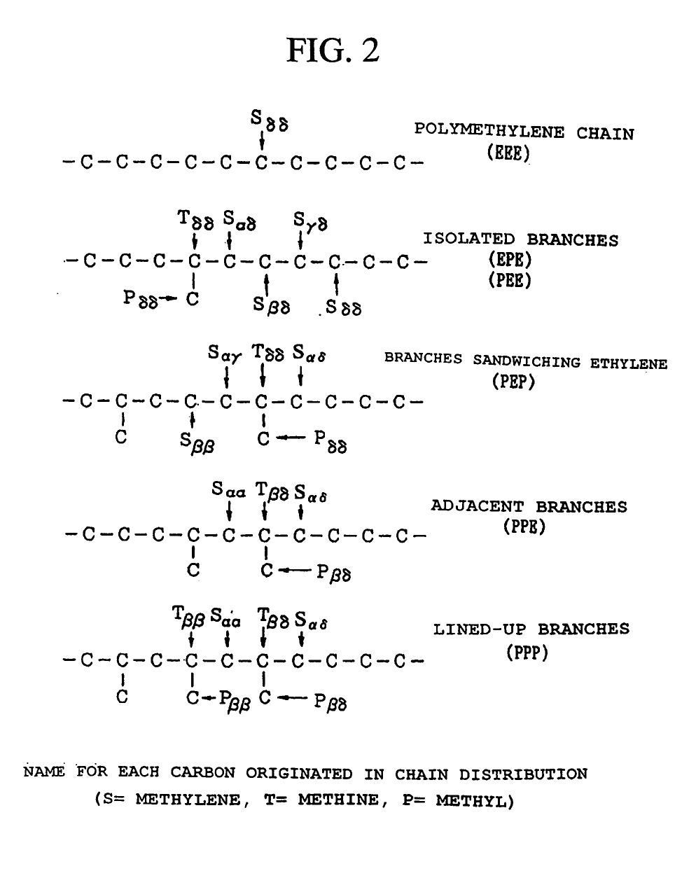

FIG. 1 is a ¹³C-NMR spectrum of a typical propylene-ethylene copolymer elastomer. In the spectrum, 10 different peaks are present due to difference in the chain distribution (the manner in which ethylene and propylene are lined up). The names for the chains are described in Macromolecules, Vol. 10, pp. 536-544 (1977) and the chains are named as in FIG. 2. Assuming a copolymerization reaction mechanism, these chains can be expressed as a product of reaction probabilities. Accordingly, when the total peak strength is assumed to be 1, the relative strength of each of the peaks (1) to (10) can be expressed by a probability equation according to Bernoulli statistics using the reaction probabilities and abundance ratio of each site as parameters. For example, in the case of (1) Sαα, when propylene is indicated by a symbol “P” and ethylene is indicated by a symbol “E”, the probable chains are 3 chains of [PPPP], [PPEE] and [EPPE]. These chains are each expressed by a reaction probability and then totaled. As for the remaining peaks (2) to (10), equations are also established in the same manner. Then, the reaction probabilities at two active sites can be determined by optimizing the parameters, namely, Pₚ, P′ₚ and P_{fl}, such that these 10 equations come closest to the actually measured peak strengths. In the optimization, a regressive calculation is performed by a method of least squares until the residual between the measured values of peak strength and the theoretical values obtained by respective equations shown in Table 1 becomes 1×10⁻⁵ or less.

The production method of the polypropylene resin composition (A) is described below. The production method for the polypropylene resin composition (A) is not particularly limited and a known method may be employed, such as a blend method of producing the composition by blending the component (C) and the component (D), a polymerization method of producing the composition by performing multistage polymerization at the polymerization, and a method using a polymerization method and a blend method in combination.

For example, in the blend method, the component (C) and the component (D) are mixed by using a ribbon blender, a tumbler, a Henschel mixer or the like, and then melt-kneaded at a temperature of 170 to 280° C., preferably from 190 to 260° C., by using a kneader, a mixing roll, a Banbury mixer, a single-screw or twin-screw extruder or the like to obtain the polypropylene resin composition (A).

In the polymerization method, the component (C) and the component (D) may be produced in one polymerization vessel by multistage polymerization. Furthermore, by using the polymerization method and the blend method in combination, after the component (C) and the component (D) are produced in one polymerization system by multistage polymerization, the component (C) and/or the component (D) may be further added.

Among these production methods of the polypropylene resin composition (A), the polymerization method is preferred, because more excellent transparency can be obtained.

In the above-described production method of the polypropylene resin composition (A), the relationship between the production conditions and the requirements (I) to (V) is described by taking the case of using the polymerization method as an example. In the polymerization method, a monomer mixture of hydrogen, propylene, ethylene and/or α-olefin having from 4 to 12 carbon atoms is used as the mixed raw material.

(I) The Fₚ changes for the higher by increasing the propylene content in the mixed raw material.

(II) The [η]_{Xs} changes for the higher by decreasing the hydrogen content in the mixed raw material.

(III) In ([η]_{Xs}/[η]_{Xi}), the [η]_{Xi} is mainly originated in the component (C) and therefore, the [η]_{Xi} changes for the higher by decreasing the hydrogen concentration in the mixed raw material at the polymerization of the component (C).

The [η]_{Xs} is mainly originated in the component (D) and therefore, the [η]_{Xs} changes for the higher by decreasing the hydrogen concentrating in the mixed raw material at the polymerization of the component (D).

Accordingly, the ([η]_{Xs}/[η]_{Xi}) can be adjusted by changing the hydrogen concentration in the mixed raw material at the polymerization of each of the component (C) and the component (D).

(IV) and (V): The relationship between Pₚ, P′ₚ and P_{fl} defined by the two-site model and the compositional ratio in the mixed raw material at the polymerization is described below.

When the propylene content in the mixed raw material is increased, the Pₚ changes for the larger, the P′ₚ is kept almost constant or changes for the slightly larger, and the Pₚ/P′ₚ value is kept almost constant or changes for the slightly smaller.

Also, when the propylene content in the mixed raw material is increased, the P_{fl} changes for the larger, as a result, the P_{fl}/(1-P_{fl}) value changes for the larger.

The ethylene-base copolymer (B) is a random copolymer of an ethylene and at least one α-olefin having 4 or more carbon atoms. By incorporating this ethylene-base copolymer (B) into the polypropylene resin composition (A), the transparency is more enhanced than in the case of using the component (A) alone.

Examples of the α-olefin having 4 or more carbon atoms, constituting the ethylene-base copolymer (B), include butene, 4-methyl-1-pentene, 1-hexene, 1-octene, 1-decene and 1-undecene. These α-olefins can be used individually or in combination of two or more thereof. Specific examples of the component (B) include an ethylene-butene random copolymer, an ethylene-hexene random copolymer and an ethylene octene random copolymer. Among these, an ethylene-butene random copolymer is preferred, because excellent impact resistance can be obtained.

The density of the ethylene-base copolymer (B) is usually from 0.870 to 0.905 g/cm³, preferably from 0.880 to 0.900 g/cm³. If an ethylene-base copolymer having a density out of the above-described range is used, the transparency may decrease after sterilizing the polypropylene-base molded article.

The MFR (a value determined at 190° C. under a load of 21.18 N according to JIS K 7210) of the ethylene-base copolymer (B) is usually from 0.1 to 20 g/10 min, preferably from 0.5 to 10 g/10 min. If the MFR is less than 0.1 g/10 min. the moldability is liable to decrease, whereas if it exceeds 20 g/10 min, the impact resistance tends to decrease.

Specific examples of the commercial product coming under the ethylene-base copolymer (B) include TAFMER (available from Mitsui Chemicals, Inc.), EBM (available from JSR Corp.), ENGAGE (available from Dow Chemical Nippon) and Excellen (available from Sumitomo Chemical Co., Ltd.).

In the thermoplastic resin composition containing these components (A) and (B), the blending ratio of the polypropylene resin composition (A) to the ethylene-base copolymer (B) is usually, in terms of component (A): component (B), from 90:10 to 40:60, preferably from 80:20 to 50:50, more preferably from 70:30 to 50:50. If the blending ratio is out of this range, the scratch resistance, impact resistance and transparency are not satisfied in some cases.

In the thermoplastic resin composition, the refractive index of the xylene-soluble portion is preferably from 1.480 to 1.495, more preferably from 1.480 to 1.490. When the refractive index of the xylene-soluble portion is in this range, the impact resistance and the transparency both are excellent. If the refractive index of the xylene-soluble portion in the thermoplastic resin composition is less than 1.480 or exceeds 1.495, the transparency tends to decrease. The refractive index of the xylene-soluble portion in the thermoplastic resin composition becomes higher when the ethylene-base copolymer (B) used has a high density, and becomes lower when an ethylene-base copolymer (B) having a low density is used.

The amount of the xylene-soluble portion in the thermoplastic resin composition is preferably from 20 to 70% by mass. If the amount of he xylene-soluble portion is less than 20% by mass, the impact strength at low temperatures is liable to be insufficient, whereas if it exceeds 70% by mass, unsatisfactory heat resistance may result. The amount of the xylene-soluble portion in the thermoplastic resin composition becomes larger when the amount of the component (B) and/or the component (D) is increased.

In the thermoplastic resin composition, the ratio (MFR_{A}/MFR_{B}) of MFR (MFR_{A}) of the polypropylene resin composition (A) to MFR (MFR_{B}) of the ethylene-base copolymer (B) is preferably from 0.3 to 3.0, more preferably from 0.3 to 2.5, still more preferably from 0.3 to 2.0. If the MFR ratio is less than 0.3, the impact resistance at low temperatures tends to be insufficient, whereas if it exceeds 3.0, fish eyes are generated in the film and the appearance is readily impaired.

In the thermoplastic resin composition, other polymers can be blended within the range of not impairing the object of the present invention. Specific examples of other polymers which can be blended in the thermoplastic resin composition include polyethylene-base resins such as high-pressure process low-density polyethylene, linear low-density polyethylene and high-density polyethylene, various styrene-base elastomers such as styrene-butadiene elastomer and its hydrogenated product, a random copolymer of propylene and an α-olefins having 4 or more carbon atoms, an ethylene-vinyl acetate copolymer, a copolymer of ethylene and (meth)acrylic acid (ester), and an olefin-base thermoplastic elastomer. The content ratio of these other polymers is preferably less than 40% by mass in 100% by mass of the thermoplastic resin composition.

The production method of the thermoplastic resin composition includes a method of kneading the components (A) and (B) and if desired, other polymers by using an extruder before molding (melt blend) and a method of blending the components (A) and (B) each in the form of a pellet (dry blend). In the melt blend, the pellets are melt-kneaded and then subjected to molding, and in the dry blend, the pellets after blending are directly subjected to molding. Among these methods, the melt blend is preferred because of excellent impact resistance.

In the case where the polypropylene-base molded article is a multilayer molded article, the molded article may have a layer comprising a thermoplastic resin composition and a layer comprising a polyolefin-base resin. By constituting such a layer structure, a molded article having objective properties can be easily obtained.

The polyolefin-base resin is preferably the above-described polypropylene resin composition (A) or a polyethylene-base resin, and because of high impact strength at low temperatures, more preferably a polyethylene-base resin.

In the polypropylene resin composition (A) constituting the layer comprising a polyolefin-base resin, an elastomer can be added within the range of not causing a problem. Specific examples of the elastomer which can be added include an ethylene-α-olefin elastomer and a hydrogenated styrene-base elastomer. Examples of the commercial product therefor include TAFMER (available from Mitsui Chemicals, Inc.), EBM (available from JSR Corp.), ENGAGE (available from Dow Chemical Nippon), Excellen (available from Sumitomo Chemical Co., Ltd.), DYNARON (available from JSR Corp.), CEPTON (available from Kuraray Co., Ltd.), TAFTEC (available from Asahi Kasei Corp.) and CRAYTON (available from Shell Japan).

The polyethylene-base resin constituting the layer comprising a polyolefin-base resin is selected from a linear low-density polyethylene (LLDPE), a high-pressure process low-density polyethylene (LDPE) and a high-density polyethylene (HDPE). However, the polyethylene-base resin except for HDPE preferably contains HDPE in view of heat resistance.

The linear low-density polyethylene (LLDPE) is a linear copolymer comprising an ethylene and an α-olefin having from 3 to 12 carbon atoms. Examples of the α-olefin constituting the linear low-density polyethylene include propylene, 1-butene, 4methyl-1-pentene, 1-hexene, 1-octene, 1-decene and 1-undecene.

The density of the linear low-density polyethylene (LLDPE) is usually from 0.905 to 0.940 g/cm³, preferably from 0.905 to 0.930 g/cm³. If the density is less than 0.905 g/cm³, the films readily undergo blocking with each other, whereas if it exceeds 0.940 g/cm³, the transparency tends to be insufficient.

The MFR (a value determined at 190° C. under a load of 21.18 N according to JIS K 7210) of the linear low-density polyethylene is usually from 0.1 to 20 g/10 min, preferably from 0.5 to 10 g/10 min. If the MFR is less than 0.1 g/10 min, the moldability tends to decrease, whereas if it exceeds 20 g/10 min, the impact resistance tends to decrease.

The polymerization catalyst which is used at the production of this linear low-density polyethylene is not particularly limited, but a Ziegler-Natta catalyst, a metallocene catalyst or the like is suitably used.

The high-pressure process low-density polyethylene (LDPE) is a polymer of an ethylene alone or a copolymer of an ethylene and a small amount of another polymerizable monomer (for example, vinyl acetate), produced by a conventionally known method, for example, by high-pressure radical polymerization.

The density of the high-pressure process low-density polyethylene is usually on the order of 0.905 to 0.940 g/cm³, preferably from 0.910 to 0.940 g/cm³.

The MFR (a value determined at 190° C. under a load of 21.18 N according to JIS K 7210) of the high-pressure process low-density polyethylene is usually from 0.1 to 20 g/10 min, preferably from 0.5 to 10 g/10 min. If the MFR is less than 0.1 g/10 min, the moldability tends to decrease, whereas if it exceeds 20 g/10 min, the impact resistance tends to decrease.

The high-density polyethylene (HDPE) is a copolymer comprising an ethylene and an α-olefin having from 3 to 12 carbon atoms. Examples of the α-olefin constituting the high-density polyethylene include propylene, 1-butene, 4-methyl-1-pentene, 1-hexene, 1-octene, 1-decene and 1-undecene.

The density of the high-density polyethylene is usually 0.945 g/cm³ or more, preferably 0.950 g/cm³ or more. If the density is less than 0.945 g/cm³, the heat resistance tends to decrease.

The MFR (a value determined at 190° C. under a load of 21.18 N according to JIS K 7210) of the high-density polyethylene is usually from 0.1 to 20 g/10 min, preferably from 0.5 to 10 g/10 min. If the MFR is less than 0.1 g/10 min, the moldability tends to decrease, whereas if it exceeds 20 g/ 10 min, the impact resistance tends to decrease.

In the case where the polyethylene-base resin except for HDPE contains HDPE, the content of HDPE is preferably 15% by mass or more in view of heat resistance. When the heat resistance is important, the polyethylene-base resin more preferably comprises substantially only HDPE.

The total thickness of the polypropylene-base molded article is not particularly limited and may be appropriately determined as desired, but the total thickness is preferably from 0.01 to 1 mm, more preferably from 0.1 to 0.5 mm. When the total thickness is within this range, the molded article can be more excellent in the transparency and flexibility.

In the case of a multilayer molded article, the thickness of the thermoplastic resin layer preferably accounts for 40% or more in view of heat resistance, transparency and impact resistance. Furthermore, in the case of a three-layer structure, the thickness ratio is preferably first layer; intermediate layer: second layer=1 to 30:40 to 98:1 to 30 (assuming that the total thickness is 100).

The molded article may have appropriately a layer comprising another resin within the range of not departing from the scope of the present invention. Specific examples of the another resin include a linear low-density polyethylene, a high-density polyethylene, a high-pressure process low-density polyethylene, a polypropylene homopolymer, an ethylene-propylene random copolymer, an ethylene-vinyl alcohol copolymer (EVOH), polyamides such as 6-nylon and 6,6-nylon, and polyesters such as polyethylene terephthalate and polybutylene terephthalate.

Also, in the resin constituting the molded article, additives may be appropriately added within the range of not departing from the scope of the present invention. Specific examples of the additive include an antistatic agent, an antioxidant, a lubricant, an antiblocking agent, an anticlouding agent, an organic or inorganic pigment, an ultraviolet absorbent and a dispersant.

The production method of the polypropylene-base molded article is not particularly limited, but examples thereof include a method of producing a single-layer, multilayer or laminated film or sheet by a single-layer or multilayer extrusion water-cooling or air-cooling inflation method, a single-layer or multilayer extrusion T-die casting method, a dry lamination method or an extrusion lamination method. Among these, preferred are a multilayer co-extrusion water-cooling inflation molding method and a multilayer co-extrusion T-die casting method, because the objective molded article can be easily obtained. In particular, a multilayer co-extrusion water-cooling inflation molding method is advantageous in many points such as transparency and hygiene.

The production method of the polypropylene-base molded article also includes a method of producing a single-layer or multilayer blow molded article by a single-layer or multilayer blow molding method.

In the polypropylene-base molded article, a layer formed by vapor deposition of an inorganic compound may be stacked.

The polypropylene-base molded article described in the foregoing pages is a single-layer or multilayer molded article having a layer comprising a thermoplastic resin composition and the thermoplastic resin composition contains a specific polypropylene resin composition (A) satisfying the requirements described above and an ethylene-base copolymer (B) comprising an ethylene and at least one α-olefin having 4 or more carbon atoms, so that the molded article can be excellent in all of heat resistance, transparency, impact resistance, flexibility and blocking resistance.

<Container>

The container of the present invention is described below. The container of the present invention comprises the above-described polypropylene-base molded article, for example, the container is a polypropylene-base molded article itself which is a tube with one opening being heat-sealed, or a blow molded article obtained by superposing at least two sheets or films and heat-sealing three or four edges.

In the case of a multilayer container, the innermost layer is preferably a layer comprising the thermoplastic resin composition for use in the present invention, a layer comprising the polypropylene resin composition (A) or a layer containing a polyethylene-base resin, and in view of hygiene, blocking resistance and heat resistance, more preferably a layer containing a polyethylene-base resin.

The layer containing a polyethylene-base resin preferably contains 15% by mass or more of HDPE and since excellent resistance can be obtained against heat and blocking at high-pressure steam sterilization at 121° C., this layer more preferably comprises substantially only HDPE. The term “substantially” is used here because a slight amount of catalyst, additive or the like used for the polymerization is sometimes contained.

The container having an innermost layer comprising substantially only HDPE and a layer adjacent to the innermost layer and comprising the thermoplastic resin composition for use in the present invention may undergo separation between layers at edges of the heat seal part when the container housing contents is dropped and an excessive force is applied to the heat seal part. However, by providing an adhesive layer comprising a linear low-density polyethylene or the like between the layer comprising substantially only HDPE and the layer comprising the thermoplastic resin composition for use in the present invention, the interlayer separation can be prevented and a preferred container highly strong against the inner pressure can be obtained.

In the case of a multilayer container, the outermost layer preferably comprises the polypropylene resin composition (A), a propylene-α-olefin random copolymer or a polyethylene-base resin.

The propylene-α-olefin random copolymer is a random copolymer comprising a propylene, an ethylene and/or an α-olefin having from 4 to 12 carbon atoms. Examples of the α-olefin constituting the propylene-α-olefin random copolymer include 1-butene, 1-pentene, 1-hexene, 1-heptene, 1-octene, 1-decene and 4-methyl-1-pentene. In the propylene-α-olefin random copolymer, these α-olefins may be used individually or in combination of two or more thereof.

In the case where the outermost layer comprises a polyethylene-base resin, the polyethylene-resin preferably contains 15% by mass or more of HDPE. The polyethylene-base resin more preferably comprises substantially only HDPE.

When the heat resistance is important, the outermost layer preferably comprises the polypropylene resin composition (A) or a propylene-α-olefin random copolymer, and when the heat resistance and blocking resistance are important, the outermost layer more preferably comprises the polypropylene resin composition (A). On the other hand, when the low-temperature impact resistance, blocking resistance and scratch resistance of film are important, the outermost layer preferably comprises substantially only HDPE.

In the case where the outermost layer comprises the polypropylene resin composition (A) or a propylene-α-olefin random copolymer, an elastomer may be added within the range of not causing a problem. Examples of the elastomer include an ethylene-α-olefin elastomer and a hydrogenated styrene-base elastomer. The commercial products described above can be used as the elastomer.

In the resin constituting the container, other resins and additives may be appropriately blended within the range of not departing from the scope of the present invention. The other resins and additives which can be used include resins comprising the above-described other polymers which can be blended in the thermoplastic resin composition, and the same additives as those which can be added to the resin constituting the polypropylene-base molded article. However, in view of elution into the content fluid, it is preferred not to add additives to the resin constituting the innermost layer.

On the container surface, a layer formed by vapor deposition of an inorganic compound may be stacked.

[Medical Container]

The container of the present invention can be suitably used as a medical container for housing a medical substance. This medical container uses the above-described container and therefore, is heat-resistant enough for sterilization at 121° C. and excellent in the transparency and impact resistance after the sterilization treatment.

Examples of the medical substance include physiological saline, an electrolyte solution, an infusion solution of dextran preparation, mannitol preparation, sugar preparation, amino acid preparation or the like, and blood ingredients such as red blood cell, platelet and blood plasma.

According to the intended use, this medical container may have two or more chambers for housing medical substances. In such a multi-chamber medical container having two or more chambers, two or more medical substances described above, which cannot be dissolved or mixed until immediately before use so as to prevent changes due to hydrolysis or blending, are stored in separate housing chambers divided, for example, by a separable adhesion part, a clamp or a partitioning member through which the chambers can be later communicated, and the plurality of medical substances can be mixed on use in the closed state without generating foreign matters, for example, by separating the adhesion part, removing the clamp or allowing the communication through the partitioning member.

### EXAMPLES

The present invention is described below by referring to Examples, but the present invention is not limited to these Examples.

<Polypropylene Resin Composition (A)>

The production example of the polypropylene resin composition is described below. In Production Examples 1 to 5 below, the component (C) is produced in the first stage of multistage polymerization and the component (D) is subsequently produced in the second stage.

### (Production Example 1: Production of PB-1)

Preparation of Polymerization Catalyst:

56.8 g of anhydrous magnesium chloride was completely dissolved in 100 g of anhydrous ethanol, 500 ml of Vaseline oil “CP15N” produced by Idemitsu Kosan Co., Ltd., and 500 ml of silicone oil “KF96” produced by Shin-Etsu Silicone Co. at 120° C. in a nitrogen atmosphere. The resulting mixture was stirred at 5,000 rpm for 2 minutes at 120° C. by using TK Homomixer manufactured by Tokushu Kika Kogyo Co., Ltd. While maintaining the stirring, the mixture was transferred into 2 liter of anhydrous heptane by taking care not to exceed 0° C., as a result, a white solid was obtained. This white solid was thoroughly washed with anhydrous heptane, vacuum-dried at room temperature and then partially subjected to removal of ethanol in a nitrogen stream. Thereafter, 30 g of the obtained MgCl₂.1.2C₂H₅OH as a spherical solid was suspended in 200 ml of anhydrous heptane and while stirring at 0° C., 500 ml of titanium tetrachloride was added dropwise over 1 hour. The resulting mixture was heated and when the temperature reached 40° C., 4.96 g of diisobutyl phthalate were added. Then, the temperature was elevated to 100° C. over about 1 hour and after the reaction was allowed to proceed at 100° C. for 2 hours, the solid portion was collected by hot filtration. To this reaction product, 500 ml of titanium tetrachloride was added and stirred and then the reaction was allowed to proceed at 120° C. for 1 hour. After the completion of reaction, the solid portion was again collected by hot filtration and washed 7 times with 1.0 liter of hexane at 60° C. and 3 times with 1.0 liter of hexane at room temperature to obtain a polymerization catalyst. The titanium content in the obtained polymerization catalyst component was measured and found to be 2.36% by mass.

1) Prepolymerization

In a nitrogen atmosphere, 500 ml of n-heptane, 6.0 g of triethylaluminum, 0.99 g of cyclohexylmethyldimethoxysilane and 10 g of the polymerization catalyst obtained above were charged into a 3 liter-volume autoclave and stirred at a temperature of 0 to 5° C. for 5 minutes. Thereafter, the prepolymerization was performed at a temperature of 0 to 5° C. for 1 hour by supplying propylene into the autoclave such that 10 g of propylene was polymerized per g of the polymerization catalyst. The thus-obtained prepolymerization catalyst was washed 3 times with 500 ml of n-heptane and used for the polymerization below.

2) Main Polymerization

First Stage: Production of Polypropylene Component (C)

In a nitrogen atmosphere, 2.0 g of the prepolymerization catalyst prepared above, 11.4 g of triethylaluminum and 1.88 g of cyclohexylmethyldimethoxysilane were charged into an autoclave equipped with a stirrer and having an inner volume of 60 liter. Subsequently, 18 kg of propylene and hydrogen in an amount of giving a concentration of 5,000 mol ppm based on the propylene were supplied and by elevating the temperature to 70° C., the polymerization was performed for 1 hour. After 1 hour, the unreacted propylene was removed and the polymerization was terminated.

Second Stage: Production of Propylene-ethylene Copolymer Elastomer (D)

After the completion of polymerization in the first stage, the liquid propylene was removed and then polymerization was performed for 60 minutes at a temperature of 75° C. by supplying a mixed gas of ethylene/propylene (=26/74 (mass ratio)) at a rate of 2.2 Nm³/hour and at the same time, supplying hydrogen to give a concentration of 40,000 mol ppm based on the total amount of ethylene, propylene and hydrogen. Thereafter, the unreacted gas was removed and the polymerization was terminated. As a result, 6.6 kg of the polymer was obtained.

(Production Example 2: production of PB-2)

The polymerization was performed in the same manner as in Production Example 1 except that in the production of propylene-ethylene copolymer elastomer (D) of the second stage, the amount of hydrogen supplied was changed to 20,000 mol ppm. As a result, 5.8 kg of the polymer was obtained.

(Production Example 3: Production of PB-3)

The polymerization was performed in the same manner as in Production Example 1 except that in the polymerization of the second stage, the amount of hydrogen supplied was changed to 30,000 mol ppm and the polymerization was performed for 45 minutes. As a result, 6.1 kg of the polymer was obtained.

(Production Example 4: Production of PB-4)

The polymerization was performed in the same manner as in Production Example 1 except for changing the mass ratio of the ethylene/propylene mixed gas to 50/50.

(Production Example 5: Production of PB-5)

The polymerization was performed in the same manner as in Production Example 1 except for changing the mass ratio of the ethylene/propylene mixed gas to 38/62.

The physical values of each component (A) produced as above are shown in Table 2. The physical values in Table 2 were measured by the following methods.

Measurement of Melt Flow Rate (MFR):

The MFR was measured according to JIS K 7210 under the conditions that the temperature was 230° C. and the load was 21.18 N. Measurement of ¹³C-NMR (calculation of Pₚ, P′ₚ and P_{fl}):

The measurement was performed by using JNM-GSX400 manufactured by JEOL Ltd. (measuring mode: proton decoupling method, pulse width: 8.0 μs, pulse repetition time: 3.0 s, number of integrations: 10,000 times, measuring temperature: 120° C., internal standard: hexamethyldisiloxane, solvent: 1,2,4-trichlorobenzene/benzene-d6 (volume ratio: 3/1), sample concentration: 0.1 g/ml) and from the data obtained, statistical analysis was performed according to the two-site model to determine Pₚ, P′ₚ and P_{fl}.

Measurement of Amount of Xylene-Soluble Portion Xₛ:

10 g of a test sample was added to 1 L of ortho-xylene and stirred under heating and by elevating the temperature to the boiling temperature (about 135° C.), the test sample was completely dissolved over 30 minutes or more. After confirming the complete dissolution with an eye, the solution was allowed to cool with stirring to 100° C. or less and further held for 2 hours in a constant temperature chamber kept at 25° C. Thereafter, the precipitated component (xylene-insoluble portion Xᵢ) was separated through a filter paper to obtain a filtrate. While heating this filtrate at a temperature of 140° C., xylene was distilled out in a nitrogen stream (about 1 L/min) and the residue was dried to obtain the xylene-soluble portion Xₛ. At this time, the drying of the xylene-insoluble portion and xylene-soluble portion was performed at 60° C. under reduced pressure for 1 day. The content of the xylene-soluble potion Xₛ can be determined by (mass of Xₛ/mass of test sample).

Measurement of Propylene Content Fₚ:

This was calculated based on the results of ¹³C-NMR above.

Measurement of Intrinsic Viscosity [η]:

This was measured at 135° in decalin.

Measurement of Refractive Index:

From each of the xylene-soluble portion Xₛ and the xylene-insoluble portion Xᵢ, a film having a thickness of 50 to 80 μm was produced by press-molding (each portion was preheated at 230° C. for 5 minutes, degassed for 30 seconds, pressed at 6 MPa for 1 minute and cooled for 3 minutes by a press at 30° C.). The obtained film was subjected to conditioning at an ordinary temperature for 24 hours and then the refractive index was measured by an Abbe's refractometer produced by ATAGO while using ethyl salicylate as an intermediate solution.

TABLE 2

| | | | PB-1 | PB-2 | PB-3 | PB-4 | PB-5 |
|---|---|---|---|---|---|---|---|
| (C) | Ethylene content | (% by mass) | 0 | 0 | 0 | 0 | 0 |
| First stage | Constituent amount | (% by mass) | 70 | 70 | 75 | 80 | 70 |
| (D) | Propylene content | (% by mass) | 70.0 | 70.0 | 65.0 | 44.0 | 57.0 |
| Second stage | Constituent amount | (% by mass) | 30 | 30 | 25 | 20 | 30 |
| Melt flow rate | | (g/10 min) | 1.2 | 0.8 | 1.0 | 2.5 | 1.1 |
| Content of xylene-soluble portion | | (% by mass) | 29.6 | 26.2 | 23 | 17.3 | 26.5 |
| Xᵢ | [η]_{Xi} | | 3.6 | 3.6 | 3.5 | 2.6 | 3 |
| | Refractive index | | 1.503 | 1.503 | 1.503 | 1.503 | 1.503 |
| Xₛ | [η]_{Xi} | (dL/g) | 3.3 | 4.3 | 3.6 | 4.5 | 3.2 |
| | Pₚ | (% by mass) | 81.8 | 82.5 | 80.5 | 67.6 | 74.4 |
| | P′ₚ | (% by mass) | 36.7 | 37.3 | 42.4 | 37.6 | 38.1 |
| | (Pₚ/P′ₚ) | | 2.23 | 2.21 | 1.90 | 1.80 | 1.95 |
| | P_{f1}/(1 − P_{f1}) | | 4.72 | 3.97 | 3.22 | 1.80 | 1.75 |
| | Refractive index | | 1.479 | 1.479 | 1.479 | 1.469 | 1.473 |
| | Propylene content Fₚ | (% by mass) | 73.9 | 73.4 | 71.5 | 57.0 | 61.2 |

| | | | | | |
|---|---|---|---|---|---|
| [η]_{Xs}/[η]_{Xi} | 0.92 | 1.19 | 1.03 | 1.73 | 1.07 |

The resins used other than the component (A) are shown below. In the following, MFRs of propylene-α-olefin random copolymer and styrene-base elastomer were measured according to JIS K 7210 under the conditions that the temperature was 230° C. and the load was 21.18 N, and MFRs of ethylene-base copolymer and polyethylene-base resin were measured according to JIS K 7210 under the conditions that the temperature was 190° C. and the load was 21.18 N.

<Propylene-α-Olefin Random Copolymer>

PR-1: PB222A (produced by Sun Allomer Ltd., MFR: 0.8 g/10 min, density: 0.90 g/cm³)

<Ethylene-Base Copolymer>

ER-1: ethylene-1-butene copolymer (EBM2021P, produced by JSR Corp., MFR: 1.3 g/10 min, density: 0.88 g/cm³)

ER-2: ethylene-1-butene copolymer (TAFMER A20090, produced by Mitsui Chemicals, Inc., MFR: 18 g/10 min, density: 0.89 g/cm³)

ER-3: ethylene-1-butene copolymer (EBM3021P, produced by JSR Corp., MFR: 1.3 g/10 min, density: 0.86 g/cm³)

ER-4: ethylene-1-hexene copolymer (ENGAGE 8480, produced by DuPont Dow Elastomer, MFR: 1.0 g/10 min, density: 0.902 g/cm³)

<Polyethylene-Base Resin>

Linear Low-density Polyethylene:

LL-1, MFR: 1.3 g/10 min, density: 0.921 g/cm³

High-density polyethylene:

HD-1, MFR: 3.5 g/10 min, density: 0.955 g/cm³

<Others>

Styrene-base elastomer (DYNARON 2320P, produced by JSR Corp., MFR: 3.5 g/10 min)

### Example 1

(Production of Thermoplastic Resin Composition)

70 parts by mass of PB-1 and 30 parts by mass of ER-1 were previously mixed in a Henschel mixer and then melt-kneaded by using a single-screw extruder to obtain composition pellets (Composition 1).

(Production of Film)

Using the pellets obtained above, a film having a total thickness of 230 μm was molded by a water-cooling single-layer inflation molding machine at a molding temperature of 230° C. The constitution of this film is shown in Table 4.

(Production of Sample)

The thus-obtained film was cut into a length of 20 cm and a width of 20 cm and two sheets of the resulting film were superposed. After sealing three edges, 500 ml of water was filled in the inside thereof and the remaining one edge was sealed to produce a container. The container was then subjected to a high-pressure steam sterilization treatment at 121° C. for 20 minutes. However, as for the container for the evaluation of blocking resistance, instead of filling water, the inner layers were tightly contacted with each other so as to prevent air from remaining in the inside of the container, the remaining one edge was sealed in this state and then the high-pressure steam sterilization treatment was performed at 121° C. for 20 minutes.

(Measurement of Various Physical Properties)

The results in the following measurements of various physical properties are shown in Tables 3 and 5.

[Content of Xylene-Soluble Portion]

This was measured by the method described in the “Best Mode for Carrying Out the Invention”.

[Refractive Index]

This was measured by the method described in the “Best Mode for Carrying Out the Invention”.

[Heat Resistance]

After the sterilization treatment, the outer appearance of the container was evaluated with an eye and rated as follows.

O: No deformation and no wrinkle.

x: Deformed and many wrinkles.

[Impact Resistance]

The container after sterilization was cooled to 4° C. and by dropping 5 units of the container in the horizontal state on a hard floor from a height of 100 cm, the number of units ruptured was examined.

[Transparency]

The container after sterilization was measured on the light transmittance by using U-3300 manufactured by Hitachi Ltd. according to Transparency Test in Test Methods for Plastic Medical Containers of Japanese Pharmacopoeia XIV.

[Blocking Resistance]

The container after sterilization was left standing at 23° C. for 24 hours and the force necessary for separating inner surfaces from each other was rated as follows.

O: Easily separated.

x: Not separated.

TABLE 3

| | Polypropylene Resin Composition (A) | | | Ethylene-Base Copolymer (B) | | | Thermoplastic Resin Composition | | |
|---|---|---|---|---|---|---|---|---|---|
| | | Compositional | MFR | | Compositional | MFR | Total Xs | Refractive | |
| Composition | Kind | Ratio (%) | (g/10 min) | Kind | Ratio (%) | (g/10 min) | (%) | Index | MFR Ratio |
| Composition 1 | PB-1 | 70 | 1.2 | ER-1 | 30 | 1.3 | 51.0 | 1.486 | 0.9 |
| Composition 2 | PB-3 | 97 | 1 | ER-3 | 3 | 1.3 | 26.1 | 1.479 | 0.8 |
| Composition 3 | PB-2 | 45 | 0.8 | ER-4 | 55 | 1.0 | 67.2 | 1.496 | 0.8 |
| Composition 4 | PB-1 | 70 | 1.2 | ER-2 | 30 | 18.0 | 51.0 | 1.488 | 0.1 |
| Composition 5 | PB-2 | 80 | 0.8 | ER-1 | 20 | 1.3 | 41.0 | 1.484 | 0.6 |
| Composition 6 | PB-4 | 100 | 2.5 | — | — | — | 17.9 | — | — |
| Composition 7 | PB-5 | 80 | 1.1 | ER-1 | 20 | 1.3 | 42.1 | 1.481 | 0.8 |
| Composition 8 | PB-4 | 85 | 2.5 | ER-1 | 15 | 1.3 | 30.1 | 1.480 | 1.9 |

TABLE 4

| | Inner Layer | | | | | | |
|---|---|---|---|---|---|---|---|
| | | Compositional | | Compositional | Thickness | Intermediate Layer | |
| | Material | Ratio (parts) | Material | Ratio (parts) | (μm) | Material | Thickness |
| Example 1 | — | — | — | — | — | Composition 1 | 230 |
| Example 2 | HD-1 | | — | — | 15 | Composition 2 | 200 |
| Example 3 | HD-1 | | LL-1 | 70 | 15 | Composition 3 | 200 |
| Example 4 | HD-1 | | — | — | 15 | Composition 4 | 200 |
| Example 5 | HD-1 | | LL-1 | 50 | 15 | Composition 5 | 200 |
| Comparative | — | — | — | — | — | Composition 6 | 230 |
| Example 1 | | | | | | | |
| Comparative | HD-1 | | — | — | 15 | Composition 7 | 200 |
| Example 2 | | | | | | | |
| Comparative | HD-1 | | LL-1 | 90 | 15 | Composition 8 | 200 |
| Example 3 | | | | | | | |

| | Outer Layer | | | | | |
|---|---|---|---|---|---|---|
| | | Compositional | | Compositional | Thickness | Total |
| | Material | Ratio (parts) | Material | Ratio (parts) | (μm) | Thickness (μm) |
| Example 1 | — | — | — | — | — | 230 |
| Example 2 | HD-1 | 100 | — | — | 15 | 230 |
| Example 3 | HD-1 | 100 | — | — | 15 | 230 |
| Example 4 | PB-1 | 80 | ER-1 | 20 | 15 | 230 |
| Example 5 | PR-1 | 80 | 2320P | 20 | 15 | 230 |
| Comparative | — | — | — | — | — | 230 |
| Example 1 | | | | | | |
| Comparative | PB-1 | 80 | ER-1 | 20 | 15 | 230 |
| Example 2 | | | | | | |
| Comparative | HD-1 | — | — | — | 15 | 230 |
| Example 3 | | | | | | |

TABLE 5

| | Physical Properties | | | |
|---|---|---|---|---|
| | | | | Strength |
| | | | | Against |
| | Transparency | Heat | | Rupture on |
| | (%) | Resistance | Blocking | Dropping |
| Example 1 | 77 | ◯ | ◯ | 0/5 |
| Example 2 | 64 | ◯ | ◯ | 0/5 |
| Example 3 | 73 | ◯ | ◯ | 0/5 |
| Example 4 | 66 | ◯ | ◯ | 0/5 |
| Example 5 | 78 | ◯ | ◯ | 0/5 |
| Comparative | 34 | ◯ | ◯ | 5/5 |
| Example 1 | | | | |
| Comparative | 51 | ◯ | ◯ | 0/5 |
| Example 2 | | | | |
| Comparative | 47 | X | X | 2/5 |
| Example 3 | | | | |

### Example 2

(Production of Thermoplastic Resin Composition)

97 parts by mass of PB-3 and 3 parts by mass of ER-1 were previously mixed in a Henschel mixer and then melt-kneaded by using a single-screw extruder to obtain composition pellets (Composition 2).

(Production of Film)

A three-layer film having a total thickness of 230 μm was molded by a water-cooling three-layer inflation molding machine at a molding temperature of 230° C. to have a configuration such that the intermediate layer was a layer comprising Composition 2 obtained above, the inner layer was a layer comprising HD-1 and the outer layer was a layer comprising HD-1. At this time, the inner layer and the outer layer both were formed to a thickness of 15 μm. The constitution of this film is shown in Table 4.

The (Production of Sample) and (Measurement of Various Physical Properties) were performed in the same manner as in Example 1.

### Example 3

(Production of Thermoplastic Resin Composition)

45 parts by mass of PB-2 and 55 parts by mass of ER-4A were previously mixed in a Henschel mixer and then melt-kneaded by using a single-screw extruder to obtain composition pellets (Composition 3).

(Production of Film)

A film having a total thickness of 230 μm was molded by a water-cooling three-layer inflation molding machine at a molding temperature of 230° C. to have a configuration such that the intermediate layer was a layer comprising Composition 3 obtained above, the inner layer was a layer comprising a composition obtained by previously mixing 30 parts by mass of HD-1 and 70 parts by mass of LL-1 in a Henschel mixer and then melt-kneading the mixture with use of a single-screw extruder, and the outer layer was a layer comprising HD-1. At this time, the inner layer and the outer layer both were formed to a thickness of 15 μm. The constitution of this film is shown in Table 4.

The (Production of Sample) and (Measurement of Various Physical Properties) were performed in the same manner as in Example 1.

### Example 4

(Production of Thermoplastic Resin Composition)

70 parts by mass of PB-1 and 30 parts by mass of ER-2 were previously mixed in a Henschel mixer and then melt-kneaded by using a single-screw extruder to obtain composition pellets (Composition 4).

(Production of Film)

A film having a total thickness of 230 μm was molded by a water-cooling three-layer inflation molding machine at a molding temperature of 230° C. to have a configuration such that the intermediate layer was a layer comprising Composition 4 obtained above, the inner layer was a layer comprising HD-1 and the outer layer was a layer comprising a composition obtained by previously mixing 80 parts by mass of PB-1 and 20 parts by mass of ER-1 in a Henschel mixer and then melt-kneading the mixture with use of a single-screw extruder. At this time, the inner layer and the outer layer both were formed to a thickness of 15 μm. The constitution of this film is shown in Table 4.

The (Production of Sample) and (Measurement of Various Physical Properties) were performed in the same manner as in Example 1.

### Example 5

(Production of Thermoplastic Resin Composition)

80 parts by mass of PB-2 and 20 parts by mass of ER-1 were previously mixed in a Henschel mixer and then melt-kneaded by using a single-screw extruder to obtain composition pellets (Composition 5).

(Production of Film)

A film having a total thickness of 230 μm was molded by a water-cooling three-layer inflation molding machine at a molding temperature of 230° C. to have a configuration such that the intermediate layer was a layer comprising Composition 5 obtained above, the inner layer was a layer comprising a composition obtained by previously mixing 50 parts by mass of HD-1 and 50 parts by mass of LL-1 in a Henschel mixer and then melt-kneading the mixture with use of a single-screw extruder, and the outer layer was a layer comprising a composition obtained by previously mixing 80 parts by mass of RP-1 and 20 parts by mass of DYNARON 2320P in a Henschel mixer and then melt-kneading the mixture with use of a single-screw extruder. At this time, the inner layer and the outer layer both were formed to a thickness of 15 μm. The constitution of this film is shown in Table 4.

The (Production of Sample) and (Measurement of Various Physical Properties) were performed in the same manner as in Example 1.

### Comparative Example 1

(Preparation of Film)

Using PB-4 (Composition 6), a film having a total thickness of 230 μm was molded by a water-cooling single-layer inflation molding machine at a molding temperature of 230° C. The constitution of this film is shown in Table 4.

The (Production of Sample) and (Measurement of Various Physical Properties) were performed in the same manner as in Example 1.

### Comparative Example 2

(Production of Thermoplastic Resin Composition)

80 parts by mass of PB-5 and 20 parts by mass of ER-1 were previously mixed in a Henschel mixer and then melt-kneaded by using a single-screw extruder to obtain composition pellets (Composition 7).

(Production of Film)

A film having a total thickness of 230 μm was molded by a water-cooling three-layer inflation molding machine at a molding temperature of 230° C. to have a configuration such that the intermediate layer was a layer comprising Composition 7 obtained above, the inner layer was a layer comprising HD-1, and the outer layer was a layer comprising a composition obtained by previously mixing 80 parts by mass of PB-1 and 20 parts by mass of ER-2 in a Henschel mixer and then melt-kneading the mixture with use of a single-screw extruder. At this time, the inner layer and the outer layer both were formed to a thickness of 15 μm. The constitution of this film is shown in Table 4.

The (Production of Sample) and (Measurement of Various Physical Properties) were performed in the same manner as in Example 1.

### Comparative Example 3

(Production of Thermoplastic Resin Composition)

85 parts by mass of PB-4 and 15 parts by mass of ER-1 were previously mixed in a Henschel mixer and then melt-kneaded by using a single-screw extruder to obtain composition pellets (Composition 8).

(Production of Film)

A film having a total thickness of 230 μm was molded by a water-cooling three-layer inflation molding machine at a molding temperature of 230° C. to have a configuration such that the intermediate layer was a layer comprising Composition 8 obtained above, the inner layer was a layer comprising a composition obtained by previously mixing 10 parts by mass of HD-1 and 90 parts by mass of LL-1 in a Henschel mixer and then melt-kneading the mixture with use of a single-screw extruder, and the outer layer was a layer comprising HD-1. At this time, the inner layer and the outer layer both were formed to a thickness of 15 μm. The constitution of this film is shown in Table 4.

The (Production of Sample) and (Measurement of Various Physical Properties) were performed in the same manner as in Example 1.

In Examples 1 to 5 having a constitution falling within the scope of the present invention, the container was excellent in all of transparency, heat resistance, blocking resistance and impact resistance at low temperatures. Also, by virtue of the thickness as small as 230 μm, the container had flexibility.

On the other hand, in Comparative Example 1 where a thermoplastic resin composition not containing the ethylene-base copolymer (B) was molded, the container was low in the transparency and impact resistance at low temperatures.

In Comparative Example 2 where P_{fl}/(1-P_{fl}) in the xylene-soluble portion Xₛ of the polypropylene resin composition was 2.00 or less, the transparency was low.

In Comparative Example 3 where the propylene unit in the component (D) of the propylene resin composition was less than 50% by mass and in the xylene-soluble portion Xₛ of the polypropylene resin composition, Pₚ/P′ₚ was less than 1.90 and P_{fl}/(1-P_{fl}) was 2.00 or less, the container was low in the transparency, heat resistance, blocking resistance and low-temperature impact resistance.

### INDUSTRIAL APPLICABILITY

The polypropylene-base molded article and the container of the present invention are excellent in all of heat resistance, transparency, impact strength, flexibility and blocking resistance and can be used particularly as a medical container.

1. A polypropylene-base molded article, which is a single-layer or multilayer molded article having a layer comprising a thermoplastic resin composition, wherein the thermoplastic resin composition contains a polypropylene resin composition (A) satisfying the following requirements and an ethylene-base copolymer (B) comprising an ethylene and at least one (α-olefin having 4 or more carbon atoms:
the polypropylene resin composition (A) is a composition containing from 50 to 80% by mass of a polypropylene component (C) and from 50 to 20% by mass of a copolymer elastomer component (D) of propylene, ethylene and/or α-olefin having from 4 to 12 carbon atoms,
the melt flow rate is in the range from 0.1 to 15.0 g/10 min,
the content of the unit originated in the propylene in the copolymer elastomer component (D) is from 50 to 85% by mass, and
the xylene-soluble portion Xₛ satisfies the following requirements (I) to (V):
(I) the propylene content Fₚ is from 50 to 80% by mass,
(II) the intrinsic viscosity [η]_{Xs} of the xylene-soluble portion Xₛ is from 1.4 to 5 dL/g,
(III) the ratio of the intrinsic viscosity [η]_{Xs} to the intrinsic viscosity [η]_{Xi} of the xylene-insoluble portion Xᵢ is from 0.7 to 1.5,
(IV) the propylene content (Pₚ) of the high propylene content component as defined according to the two-site model is from 60% by mass to less than 95% by mass and the propylene content (P′ₚ) of the low propylene content component is from 20% by mass to less than 60% by mass, and
(V) the propylene content (Pₚ) of the high propylene content component as defined according to the two-site model, the propylene content (P′ₚ) of the low propylene content component, the ratio (P_{fl}) of the high propylene content component occupying in Fₚ, and the ratio (1-P_{fl}) of the low propylene content component occupying in Fₚ satisfy the following formulae (1) and (2):
Pₚ/P′_{P}≧1.90 (1)
2.00<P_{fl}/(1-P_{fl})<6.00 (2).

2. The polypropylene-base molded article as claimed in claim 1, wherein the refractive index of the xylene-soluble portion in the thermoplastic resin composition is from 1.480 to 1.495.

3. The polypropylene-base molded article as claimed in claim 1, wherein the amount of the xylene-soluble portion in the thermoplastic resin composition is from 20 to 70% by mass.

4. The polypropylene-base molded article as claimed in claim 1, wherein in the thermoplastic resin composition, the ratio (MFR_{A}/MFR_{B}) of the melt flow rate (MFR_{A}) of the polypropylene resin composition (A) to the melt flow rate (MFR_{B}) of the ethylene-base copolymer (B) is from 0.3 to 3.0.

5. The polypropylene-base molded article as claimed in claim 1, which is a multilayer polypropylene-base molded article and further has a layer comprising a polyolefin-base resin.

6. The polypropylene-base molded article as claimed in claim 5, wherein the polyolefin-base resin is a polyethylene-base resin.

7. The polypropylene-base molded article as claimed in claim 6, wherein the polyethylene-base resin contains 15% by mass or more of a high-density polyethylene.

8. The polypropylene-base molded article as claimed in claim 6, wherein the polyethylene-base resin comprises substantially only a high-density polyethylene.

9. The polypropylene-base molded article as claimed in claim 1, wherein the thickness of the layer comprising a thermoplastic resin composition accounts for 40% or more of the entire thickness.

10. The polypropylene-base molded article as claimed in claim 1, which is produced by a multilayer co-extrusion water-cooling inflation molding method or a multilayer co-extrusion T-die casting method.

11. A container comprising the polypropylene-base molded article claimed in claim 1.

12. The container as claimed in claim 11, wherein the container comprises a multilayer polypropylene-base molded article and the outermost layer is a layer comprising a polypropylene resin composition or a propylene.α-olefin random copolymer.

13. The container as claimed in claim 11, wherein the container comprises a multilayer polypropylene-base molded article and the outermost layer is a layer containing a polyethylene-base resin.

14. The container as claimed in claim 13, wherein the polyethylene-base resin contains 15% by mass or more of a high-density polyethylene.

15. The container as claimed in claim 13, wherein the polyethylene-base resin comprises substantially only a high-density polyethylene.

16. The container as claimed in claim 11, wherein the container comprises a multilayer polypropylene-base molded article and the innermost layer is a layer containing a polyethylene-base resin.

17. The container as claimed in claim 16, wherein the polyethylene-base resin comprises substantially only a high-density polyethylene.

18. The container as claimed in claim 11, which is a medical container for housing a medical substance.
